(19) United States
(12) Patent Application Publication
(10) Pub. No.: US 2015/0220996 A1
(43) Pub. Date: Aug. 6, 2015

(54) SYSTEMS AND METHODS FOR VIRAL PROMOTION OF CONTENT

(71) Applicants: Venkata S.J.R. Bhamidipati, Fremont, CA (US); Yingfeng Oh, Cupertino, CA (US); Michael Grishaver, Portola Valley, CA (US); Baoshi Yan, San Jose, CA (US); Huining Feng, Dublin, CA (US)

(72) Inventors: Venkata S.J.R. Bhamidipati, Fremont, CA (US); Yingfeng Oh, Cupertino, CA (US); Michael Grishaver, Portola Valley, CA (US); Baoshi Yan, San Jose, CA (US); Huining Feng, Dublin, CA (US)

(21) Appl. No.: 14/169,570

(22) Filed: Jan. 31, 2014

(51) Int. Cl. G06Q 30/02; G06Q 50/00

(52) U.S. Cl. CPC G06Q 30/0269; G06Q 50/01; G06Q 30/0246

(57) ABSTRACT

Techniques for viral promotion of content are described. According to various embodiments, a user request to promote a content item to a member base of an online social network service is received. For example, the request to promote the content item may be received from an advertiser or marketer in conjunction with a request to receive a predetermined number of social activity signals (e.g., likes, shares, follows, comments, etc.) in association with the content item (e.g., as part of an advertising or marketing campaign). Viral promotion seed user definition information specifying one or more definitions of a viral promotion seed user is then accessed. Thereafter, a particular member of the online social network service is classified as the viral promotion seed user, based on the viral promotion seed user definition information. The content item is then selectively promoted to the viral promotion seed user.

### TECHNICAL FIELD

The present application relates generally to data processing systems and, in one specific example, to techniques for viral promotion of content.

### BACKGROUND

Many social network services such as LinkedIn® and Facebook® include “feeds” or “streams” that display various content in reverse chronological order, with newer or more recent content appearing higher in the feed. Such feeds or streams are also commonly referred to as news feeds, activity feeds, network update feeds, status feeds, data feeds, news streams, activity streams, network update streams, status streams, data streams, and so on.

### BRIEF DESCRIPTION OF THE DRAWINGS

Some embodiments are illustrated by way of example and not limitation in the figures of the accompanying drawings in which:

FIG. 1 is a block diagram showing the functional components of a social networking service, consistent with some embodiments of the invention;

FIG. 2 is a block diagram of an example system, according to various embodiments;

FIG. 3 illustrates an example of a content item, according to various embodiments;

FIG. 4 illustrates an exemplary portion of a user interface, according to various embodiments;

FIG. 5 illustrates an exemplary portion of a user interface, according to various embodiments;

FIG. 6 illustrates an exemplary portion of a content feed viewable by a viral promotion seed user, according to various embodiments;

FIG. 7 illustrates an exemplary portion of a content feed viewable by a viral promotion seed user, according to various embodiments;

FIG. 8 illustrates an exemplary portion of a content feed viewable by one or more members of an online social network service, according to various embodiments;

FIG. 9 illustrates an exemplary portion of a content feed viewable by one or more members of an online social network service, according to various embodiments;

FIG. 10 is a flowchart illustrating an example method, according to various embodiments;

FIG. 11 is a flowchart illustrating an example method, according to various embodiments;

FIG. 12 is a flowchart illustrating an example method, according to various embodiments;

FIG. 13 is a flowchart illustrating an example method, according to various embodiments;

FIG. 14 illustrates an example of virality multiplier factor information, according to various embodiments;

FIG. 15 illustrates an exemplary mobile device, according to various embodiments; and

FIG. 16 is a diagrammatic representation of a machine in the example form of a computer system within which a set of instructions, for causing the machine to perform any one or more of the methodologies discussed herein, may be executed.

### DETAILED DESCRIPTION

Example methods and systems for viral promotion of content are described. In the following description, for purposes of explanation, numerous specific details are set forth in order to provide a thorough understanding of example embodiments. It will be evident, however, to one skilled in the art that the present invention may be practiced without these specific details.

As described in various embodiments herein, a viral content promotion system is configured to encourage users to interact with a content item by notifying them that an influential user has already interacted with that content item. For example, the system may be utilized to launch a viral marketing campaign by promoting the fact that the content item is acted upon by someone influential. For example, if someone has a large number of followers, then the fact that they interacted with the content item may be broadcast to a large number of followers in a relatively short amount of time. Thus, even though a content item is first viewed by a small number of users, the content item may then be rapidly shared with more users, who in turn rapidly share the content item with even more users, and so on, resulting in a viral, ripple, or “snowball” effect where a large number of users interact with the underlying content item within a relatively short period of time.

Accordingly, the system described herein is configured to initiate or accelerate a viral marketing campaign by attempting to target a piece of content at an influential user in an attempt to make that influential user view and/or interact with (e.g., like) the content item. This influential user's interaction with the content item may then be transmitted virally to the people that may draw influence from that influential user (e.g., the influential user's followers on an online social network service), so that such followers are much more likely to interact with that content item themselves (e.g., by viewing or liking the article).

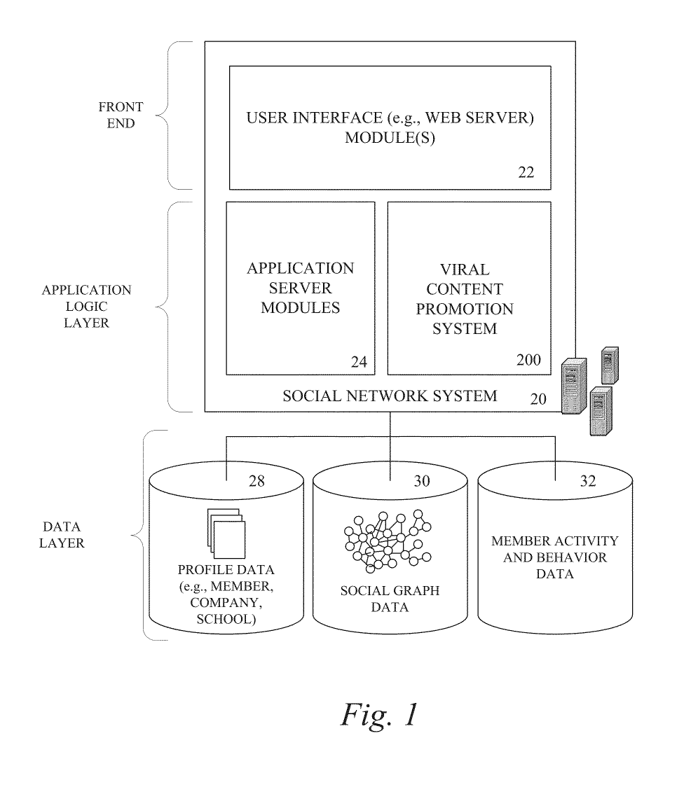

FIG. 1 is a block diagram illustrating various components or functional modules of a social network service such as the social network system 20, consistent with some embodiments. As shown in FIG. 1, the front end consists of a user interface module (e.g., a web server) 22, which receives requests from various client-computing devices, and communicates appropriate responses to the requesting client devices. For example, the user interface module(s) 22 may receive requests in the form of Hypertext Transport Protocol (HTTP) requests, or other web-based, application programming interface (API) requests. The application logic layer includes various application server modules 14, which, in conjunction with the user interface module(s) 22, generates various user interfaces (e.g., web pages) with data retrieved from various data sources in the data layer. With some embodiments, individual application server modules 24 are used to implement the functionality associated with various services and features of the social network service. For instance, the ability of an organization to establish a presence in the social graph of the social network service, including the ability to establish a customized web page on behalf of an organization, and to publish messages or status updates on behalf of an organization, may be services implemented in independent application server modules 24. Similarly, a variety of other applications or services that are made available to members of the social network service will be embodied in their own application server modules 24.

As shown in FIG. 1, the data layer includes several databases, such as a database 28 for storing profile data, including both member profile data as well as profile data for various organizations. Consistent with some embodiments, when a person initially registers to become a member of the social network service, the person will be prompted to provide some personal information, such as his or her name, age (e.g., birthdate), gender, interests, contact information, hometown, address, the names of the member's spouse and/or family members, educational background (e.g., schools, majors, matriculation and/or graduation dates, etc.), employment history, skills, professional organizations, and so on. This information is stored, for example, in the database with reference number 28. Similarly, when a representative of an organization initially registers the organization with the social network service, the representative may be prompted to provide certain information about the organization. This information may be stored, for example, in the database with reference number 28, or another database (not shown). With some embodiments, the profile data may be processed (e.g., in the background or offline) to generate various derived profile data. For example, if a member has provided information about various job titles the member has held with the same company or different companies, and for how long, this information can be used to infer or derive a member profile attribute indicating the member's overall seniority level, or seniority level within a particular company. With some embodiments, importing or otherwise accessing data from one or more externally hosted data sources may enhance profile data for both members and organizations. For instance, with companies in particular, financial data may be imported from one or more external data sources, and made part of a company's profile.

Once registered, a member may invite other members, or be invited by other members, to connect via the social network service. A “connection” may require a bi-lateral agreement by the members, such that both members acknowledge the establishment of the connection. Similarly, with some embodiments, a member may elect to “follow” another member. In contrast to establishing a connection, the concept of “following” another member typically is a unilateral operation, and at least with some embodiments, does not require acknowledgement or approval by the member that is being followed. When one member follows another, the member who is following may receive status updates or other messages published by the member being followed, or relating to various activities undertaken by the member being followed. Similarly, when a member follows an organization, the member becomes eligible to receive messages or status updates published on behalf of the organization. For instance, messages or status updates published on behalf of an organization that a member is following will appear in the member's personalized data feed or content stream. In any case, the various associations and relationships that the members establish with other members, or with other entities and objects, are stored and maintained within the social graph, shown in FIG. 1 with reference number 30.

The social network service may provide a broad range of other applications and services that allow members the opportunity to share and receive information, often customized to the interests of the member. For example, with some embodiments, the social network service may include a photo sharing application that allows members to upload and share photos with other members. With some embodiments, members may be able to self-organize into groups, or interest groups, organized around a subject matter or topic of interest. With some embodiments, the social network service may host various job listings providing details of job openings with various organizations.

As members interact with the various applications, services and content made available via the social network service, the members' behavior (e.g., content viewed, links or member-interest buttons selected, etc.) may be monitored and information concerning the member's activities and behavior may be stored, for example, as indicated in FIG. 1 by the database with reference number 32. This information may be used to classify the member as being in various categories. For example, if the member performs frequent searches of job listings, thereby exhibiting behavior indicating that the member is a likely job seeker, this information can be used to classify the member as a job seeker. This classification can then be used as a member profile attribute for purposes of enabling others to target the member for receiving messages or status updates. Accordingly, a company that has available job openings can publish a message that is specifically directed to certain members of the social network service who are job seekers, and thus, more likely to be receptive to recruiting efforts.

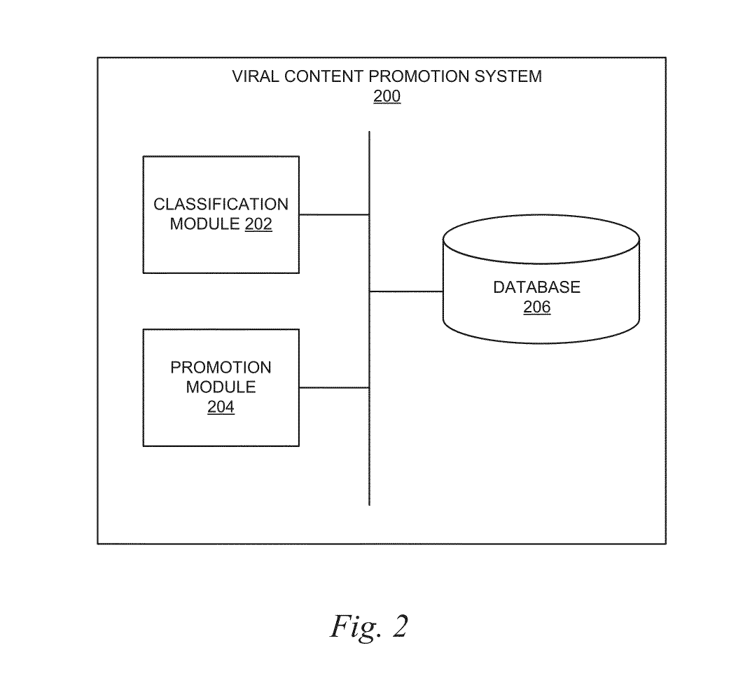

With some embodiments, the social network system 20 includes what is generally referred to herein as a viral content promotion system 200. The 200 is described in more detail below in conjunction with FIG. 2.

Although not shown, with some embodiments, the social network system 20 provides an application programming interface (API) module via which third-party applications can access various services and data provided by the social network service. For example, using an API, a third-party application may provide a user interface and logic that enables an authorized representative of an organization to publish messages from a third-party application to a content hosting platform of the social network service that facilitates presentation of activity or content streams maintained and presented by the social network service. Such third-party applications may be browser-based applications, or may be operating system-specific. In particular, some third-party applications may reside and execute on one or more mobile devices (e.g., phone, or tablet computing devices) having a mobile operating system.

As described in various embodiments herein, a viral content promotion system is configured to enable marketers and advertisers to more effectively market content through viral campaigns. For example, the system described herein is configured to utilize various viral marketing techniques in order to effectively promote content to a group of users (such as a member base of an online social network service such as LinkedIn®, Facebook®, or Twitter®) more effectively and efficiently than would be possible via conventional techniques. For example, traditional marketing techniques currently utilized in digital and online environments involve displaying advertisements to a target audience of users on behalf of a business that seeks to market products and services to those users. In other words, when a business wishes to display an advertisement to a target audience of users, an advertisement service may attempt to immediately and directly display that advertisement to that target audience of users. This may result in some impressions of the displayed content, although typically only a small subset of the users that view the content (or have the opportunity to access the content) actually proceed to interact and engage with the content in a meaningful way. For example, if the content item is displayed to 100 users in the target audience, typically only a few users will actually take the time to click on the content or submit social activity signals (e.g., likes, shares, follows, comments, etc.) in conjunction with the content. Thus, traditional marketing techniques depend on the use of “casting a wide net” and simply serving advertisements and other content directly to a large target audience, in the hopes that at least some users in the target audience will decide to view the content based solely on the merits of the content itself.

In accordance with various embodiments described herein, the viral content promotion system 200 is configured to utilize and exploit various viral social marketing techniques in order to precipitate a far greater amount of interaction between users and content items such as advertisements. The system may exploit social interconnections between users in order to encourage a first user to interact with (e.g., like, share, follow, comment on, etc.) a content item based on the fact that someone they are socially connected with (e.g., an Influencer on LinkedIn® that they follow, a user on Twitter® that they follow, their friend on Facebook®, etc.) has also interacted with that content. For example, the system exploits the fact that if an Influencer on LinkedIn® likes an item, the people that follow that Influencer will be notified of the Influencer's interaction with the content item, and thus the viral or ripple effect of this may be that the followers are more likely to interact with that content item themselves.

Turning now to FIG. 2, a viral content promotion system 200 includes a classification module 202, a promotion module 204, and a database 206. The modules of the viral content promotion system 200 may be implemented on or executed by a single device such as a content promotion device, or on separate devices interconnected via a network. The aforementioned content promotion device may be, for example, a client machine or application server.

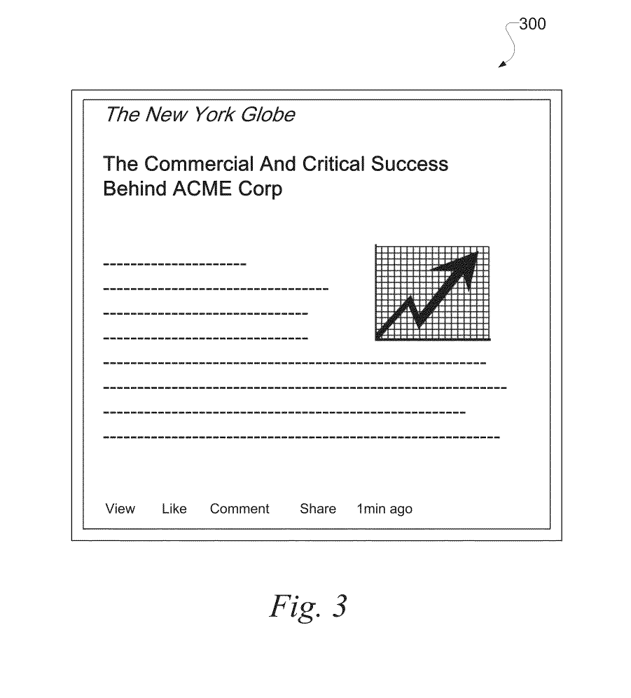

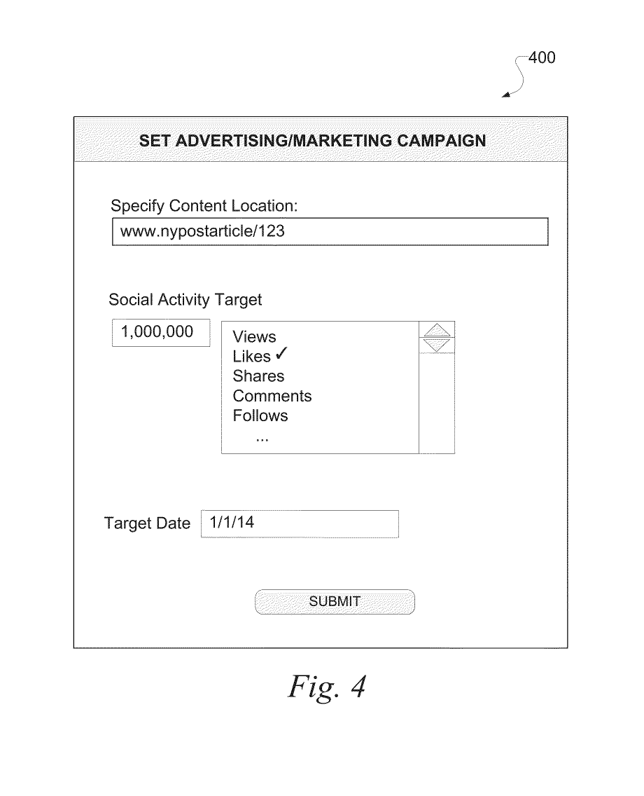

According to various exemplary embodiments, the classification module 202 of the viral content promotion system 200 is configured to receive a request to advertise, market, or otherwise promote a piece of content in a particular way to a member base of an online social network service (e.g., LinkedIn®, Facebook®, Twitter®, etc.). For example, an advertiser or marketer may have a desire that a particular advertisement or news article that presents a favourable view of a company will receive 1,000,000 likes in a month. Thus, the advertiser may have a specific advertising campaign goal of receiving a predetermined number of social activity signals (e.g., likes, shares, follows, comments, etc.) in conjunction with this content within a given time. For example, FIG. 3 illustrates an example of the content item corresponding to an article 300 that, for example, describes the ACME Corporation in a positive light. Moreover, FIG. 4 illustrates an exemplary portion of a user interface 400 that may be displayed by the classification module 202 to a user of the viral content promotion system 200. The user interface 400 enables a user to define various characteristics of a viral promotion campaign, including specifying a content item (e.g., the article 300 in FIG. 3) and a target number of social activity signals (e.g., 1 million likes) to be received by the aforementioned content item by a certain target date.

Thereafter, the classification module 202 is configured to identify a particular member of the online social network service that may function as a viral promotion seed user for an advertisement campaign. As described herein, a viral promotion seed user may be an influential member of an online social network service that may be effective at facilitating a viral marketing campaign because their interactions with content spurs others to interact with content. For example, the viral promotion seed user may have a predetermined number of followers, connections, friends, etc., on a social network service, or may be a member of LinkedIn® that is already classified as an Influencer and who has their own Influencer page, or may be a member of an online social network service that has posted (or that tends to post) content items such as posts, articles, status updates, photos, comments, etc., that themselves tend to generate a large number of social activity responses (e.g., likes, comments, shares, etc.), or may be a member that satisfies one or more social metric thresholds described in more detail below.

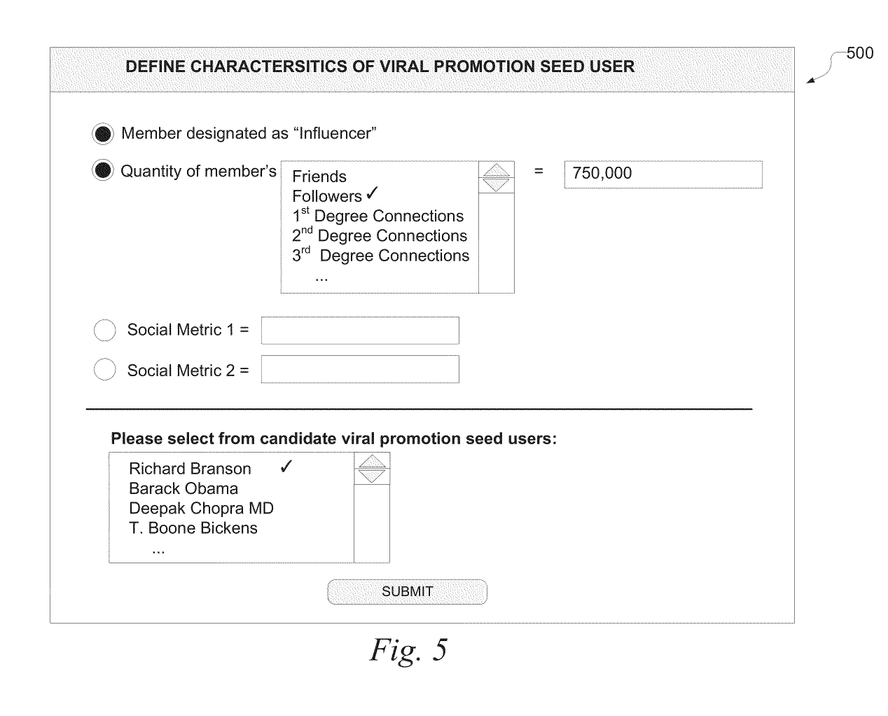

In some embodiments, the classification module 202 is configured to allow an advertiser to specify qualities and characteristics of the viral promotion seed user for an advertising or marketing campaign, such as “Influencer on LinkedIn®”, “Influencer on LinkedIn® with at least 500,000 followers”, “Twitter® user with at least 750,000 followers”, etc. For example, FIG. 5 illustrates an exemplary portion of a user interface 500 that may be displayed by the classification module 202 to a user of the viral content promotion system 200 where the user interface 500 enables a user to specify or define various characteristics of a viral promotion seed user. For example, as illustrated in FIG. 5, the user has defined the viral promotion seed user as a member designated as an Influencer and having at least 750,000 followers. As illustrated in FIG. 5, the user may also define thresholds for various social metrics (e.g., social metric 1 and social metric 2). Thus, in some embodiments, an advertiser may define a viral promotion seed user as having a predetermined number of followers, friends, or first-degree connections on an online social network service, or a member designated as an Influencer member of an online social network service (e.g., an Influencer on LinkedIn®), or member that has a threshold value for one of various social metrics. An example of a social metric is a metric indicating how many social activity signals the viral promotion seed user has submitted in conjunction with content items posted on an online social network service (e.g., within a predetermined time interval). Another example of a social metric is a metric indicating the historical likelihood that the viral promotion seed user will submit a social activity signal in conjunction with a content item after viewing the content item. Another example of a social metric is a metric indicating a number of social activity signals submitted by other users upon learning of a social activity signal submitted by the viral promotion seed user (e.g., how many likes does an article receive after the viral seed user likes the article). Another example of a social metric is a metric indicating the likelihood of a significant number of social activity signals being submitted by other users upon learning of a social activity signal submitted by the viral promotion seed user (e.g., the likelihood of an article receiving a large number of likes after the viral seed user likes the article).

As illustrated in FIG. 5, based on the user-specified criteria in user interface 500, the user interface 500 further displays a list of candidate viral promotion seed users satisfying user-specified criteria, and the user can simply select the appropriate viral promotion seed user. Although not illustrated in FIG. 5, the user interface 500 may also allow the advertiser to select any other attributes associated with the viral promotion seed user, such as age, gender, job title, skills, endorsements, employer, company size, a number of connections/followers/friends, etc.

After the classification module 202 identifies a viral promotion seed user from among a member base of an online social network service, the promotion module 204 of the viral content promotion system 200 may directly promote or target the content item that is the subject of the viral marketing campaign at the viral promotion seed user. More specifically, the classification module 202 attempts to display the content item to the viral promotion seed user (or otherwise attempts to notify the viral promotion seed user of the content item) in such a way that it is more likely that the viral promotion seed user will proceed to interact with the content, such as by liking the content, sharing the content, commenting on the content, and so on.

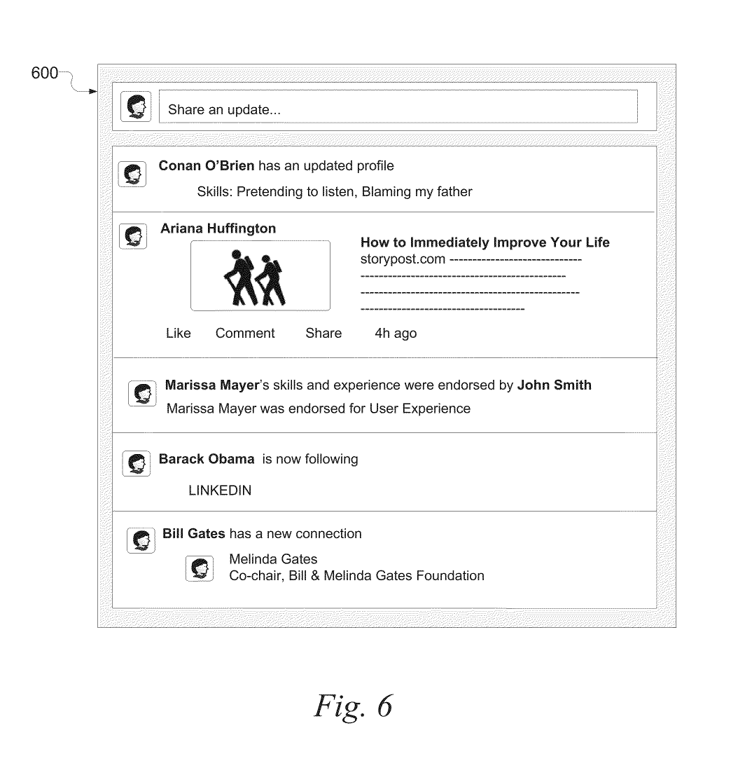

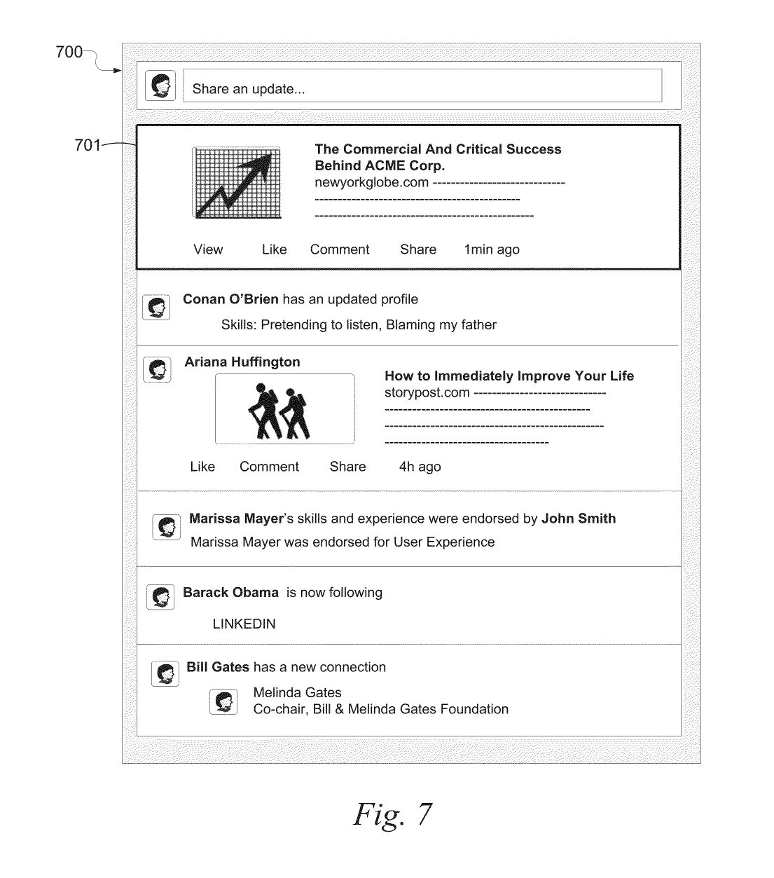

In some embodiments, the promotion module 204 may promote underlying content item at the viral promotion seed user by, for example, inserting it into a content feed viewable by that the viral promotion seed user. Thus, when the viral promotion seed user logs into an online social network service (e.g., their LinkedIn®, Facebook®, Twitter® account, etc.), the viral promotion seed user may view a content feed that includes the underlying content item (or link to the content item). For example, FIG. 6 illustrates an example of a content feed 600 that may be viewable by a viral promotion seed user, such as a content feed displayed on homepage of the LinkedIn® social network service when a viral promotion seed user (e.g., the LinkedIn® Influencer Richard Branson) logs into LinkedIn®. As illustrated in FIG. 6, the content feed 600 includes updates from various other members within the network of the viral promotion seed user. Moreover, FIG. 7 illustrates a content feed 700 similar to the content feed 600 illustrated in FIG. 6, where a status update or prompt 701 has been inserted into the content feed 700 by the promotion module 204. In particular, status update 701 identifies the article 300 describing the Acme Corporation (see FIG. 3), and includes a link for accessing the article 300. The viral promotion seed user viewing the content feed 700 may themselves submit social activity signal in conjunction with the article 300 by clicking on the appropriate link (e.g., “Like”, “Comment”, “Share”, etc.) in the prompt 701.

In some embodiments, depending on the amount of money an advertiser pays, the underlying content item may be displayed more or less prominently in the content feed viewable by the viral promotion seed user. For example, if the advertiser pays a premium fee, then the content item may be placed in a premium position (e.g., at the top) of the content feed viewable by the viral promotion seed user. In other embodiments, the content item or link thereto may be included in an e-mail transmitted to the viral promotion seed user. Other notification formats such as in mail messages on LinkedIn®, instant messages, text messages, and so on, may also be utilized. In other embodiments, it is possible that the content item may be placed on a webpage associated with the viral promotion seed user that may or may not be viewable by other users. For example, the content item may be displayed on a member profile page, a web blog page, a LinkedIn® Influencer page, and so on, associated with the viral promotion seed user, making it likely that the viral promotion seed user will see the content item and interact with it in some way.

Thereafter, when the promotion module 204 detects that the viral promotion seed user has interacted with that content item (e.g., when the viral promotion seed user clicks on “Like” in the prompt 701 in FIG. 7), information describing that interaction may be published to a large number of users, such as the entire member base of an online social network service, or the users that follow the viral promotion seed user, or all the users that have a first degree connection or friendship relationship with the viral promotion seed user, or the users that have at least some other particular degree connection (e.g., first, second, third, etc.) with the viral promotion seed user, and so on. For example, when the viral promotion seed user interacts with any type of content, this interaction will typically be published in the content feeds viewable by all the members that have a first degree connection or a friendship relationship with the viral promotion seed user, and/or all the users that follow the viral promotion seed user.

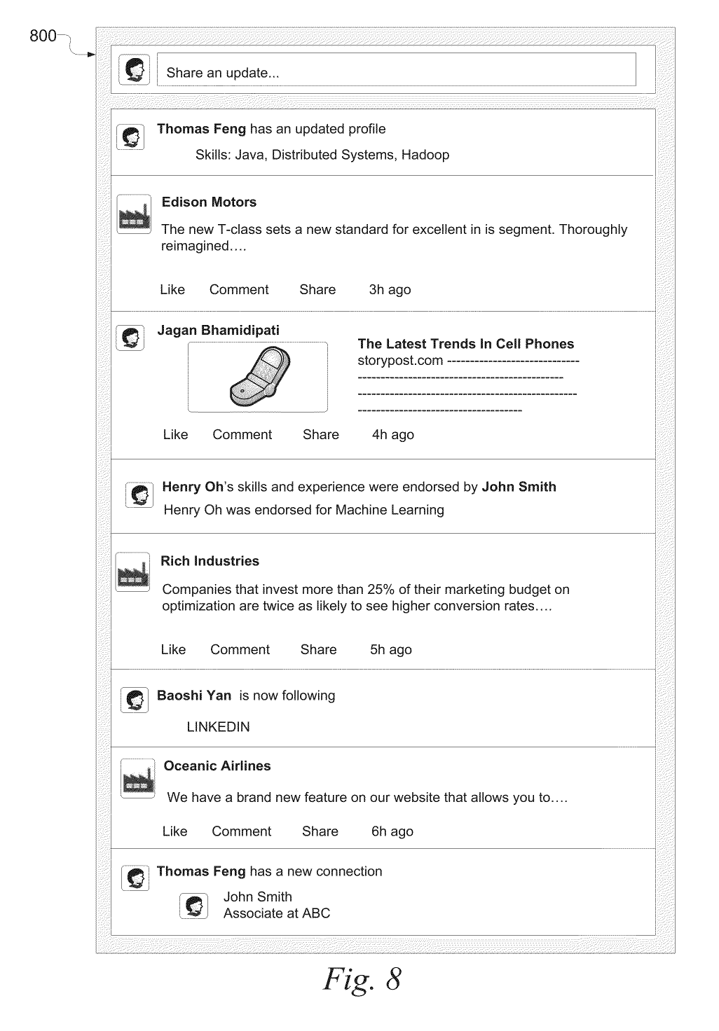

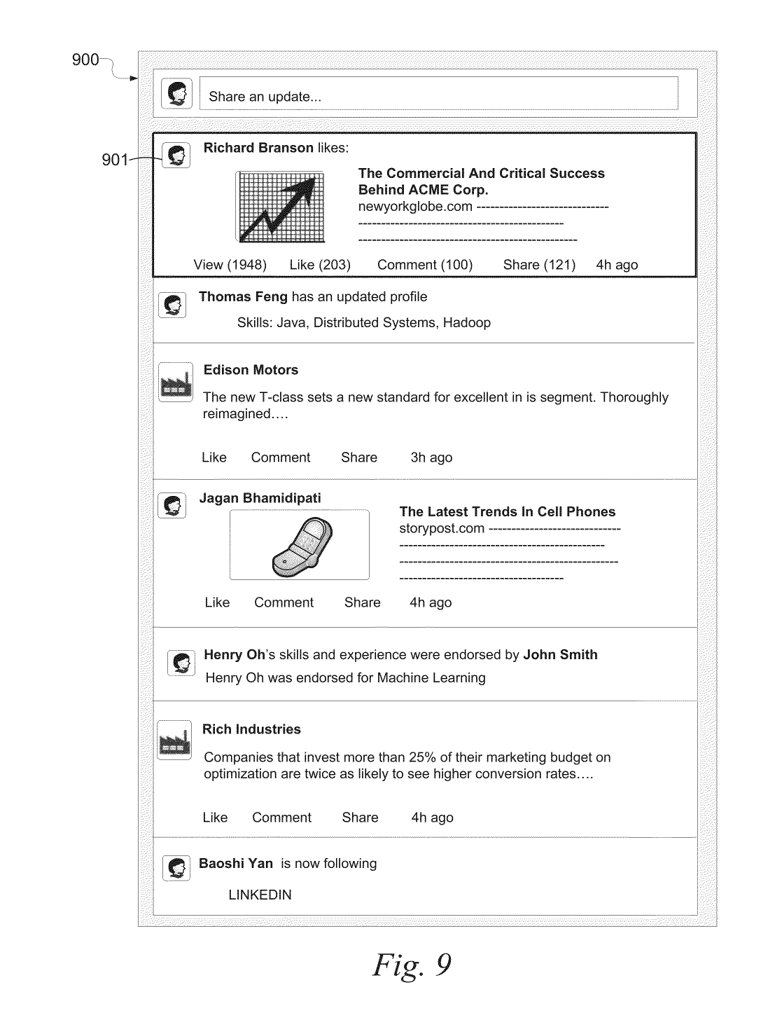

For example, FIG. 8 illustrates an example of a content feed 800 that may be viewable by one or more members of an online social network service, such as a content feed displayed on homepage of the LinkedIn® social network service when a user logs into LinkedIn®. As illustrated in FIG. 8, the content feed 800 includes updates from various other members within the network of the viewing member. Moreover, FIG. 9 illustrates a content feed 900 similar to the content feed 800 illustrated in FIG. 8, where a status update or prompt 901 has been inserted into the content feed 900 by the promotion module 204. In particular, status update 901 identifies the article 300 describing the Acme Corporation (see FIG. 3), and includes a link for accessing the article 300. Moreover, the status update 901 indicates that a viral promotion seed user for promoting the article 300 (e.g., the LinkedIn® Influencer Richard Branson) as determined by the viral content promotion system 200 has interacted with (e.g., likes) the article 300. Further, the status update 901 indicates a number of social activity signals (e.g., likes, comments, shares, etc.) received by the article 300 posted on the online social network service. The viewer of the content feed 900 may themselves submit social activity signals in conjunction with the article 300 by clicking on the appropriate link (e.g., “Like”, “Comment”, “Share”, etc.) in the prompt 901.

The content items referred to herein may be any type of content item, including electronic content items and/or online content items displayed in, or accessible by, a webpage or a user interface of a mobile application. Non-limiting examples of content items include webpages, news items, blog posts, articles, publications, presentations, slideshows, documents, reviews, pictures, videos, multimedia, webpages, rich media, text, video, advertisements, coupons, promotions, brochures, items posted in a content stream or content feed, notifications, emails, text or instant messages, message boards, bulletin boards, forums, profile pages (e.g., profile pages on a social network service such as LinkedIn®, such as member profile pages, Influencer profile pages, company profile pages, group profile pages, etc.), a song, an image, a video, a quote, a reference link (e.g., Uniform Resource Locator (URL) or Uniform Resource Identifier (URI)), and so on. In some embodiments, the social activity signals may include views, likes, comments, shares, follows, clicks, conversions, hover responses, hide responses, views of comments, likes of comments, shares of comments, etc.

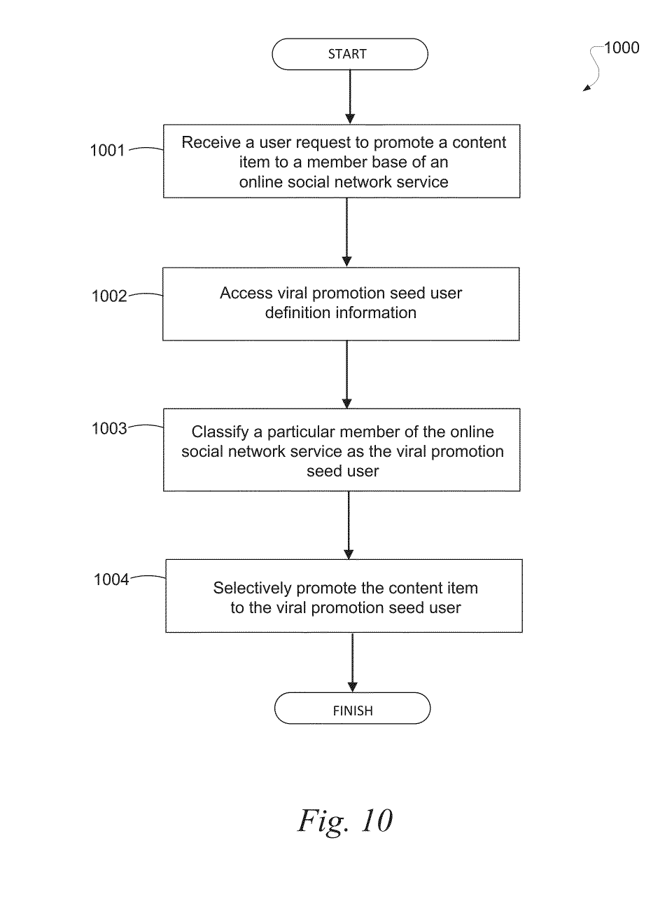

FIG. 10 is a flowchart illustrating an example method 1000, consistent with various exemplary embodiments described above. The method 1000 may be performed at least in part by, for example, the viral content promotion system 200 illustrated in FIG. 2 (or an apparatus having similar modules, such as a client machine and/or application server). In operation 1001 in FIG. 10, the classification module 202 receives a user request to promote a content item to a member base of an online social network service. As described above, the request to promote the content item may be received from an advertiser or marketer in conjunction with a request to receive a predetermined number of social activity signals (e.g., likes, shares, follows, comments, etc.) in association with the content item (e.g., see FIG. 4).

In operation 1002 in FIG. 10, the classification module 202 accesses viral promotion seed user definition information specifying one or more definitions of a viral promotion seed user. In some embodiments, the operation 1002 may comprise receiving, via a user interface, a user specification of the viral promotion seed user definition information (e.g., see FIG. 5).

In operation 1003 in FIG. 10, the classification module 202 classifies a particular member of the online social network service as the viral promotion seed user, based on the viral promotion seed user definition information. For example, the classification module 202 may identify a particular member of an online social network service that meets the definitions in the viral promotion seed user definition information (e.g., a member that has a predetermined number of followers, a member that is an influencer on LinkedIn, etc.). In some embodiments, the classification module 202 may identify a plurality of candidate viral promotion seed users, based on the viral promotion seed user definition information. The classification module 202 may then display, via a user interface, a selection of various candidate viral promotion seed users satisfying the viral promotion seed user definition information (e.g., see FIG. 5). The 204 may then receive, via the user interface, a user selection of a specific viral promotion seed user from among the selection of various candidate viral promotion seed users (e.g., see FIG. 5).

In operation 1004 in FIG. 10, the promotion module 204 selectively promotes the content item to the viral promotion seed user. For example, the promotion module 204 may post the content item or a reference link for accessing the content item in a content feed viewable by the viral promotion seed user (e.g., see FIG. 7). As another example, the promotion module 204 may post the content item or a reference link for accessing the content item on a home page, blog page, or member profile page associated with the viral promotion seed user. As another example, the promotion module 204 may transmit an email to the viral promotion seed user that includes the content item or a reference link for accessing the content item.

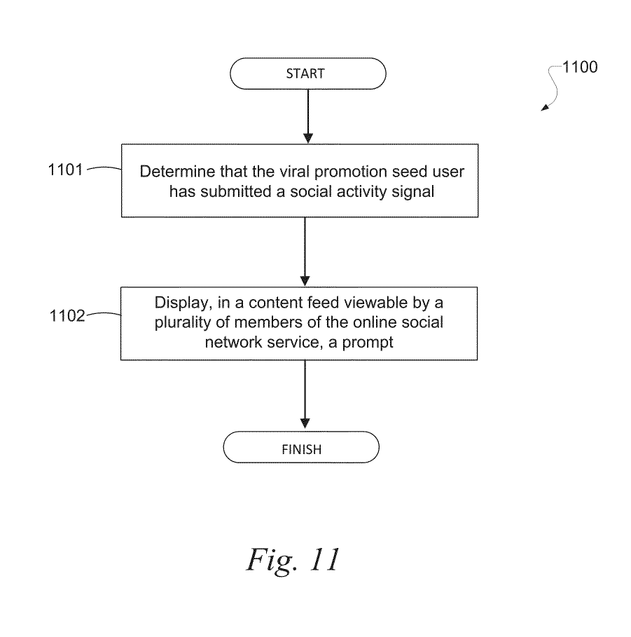

FIG. 11 is a flowchart illustrating an example method 1100, consistent with various embodiments described above. The method 1100 may be performed at least in part by, for example, the viral content promotion system 200 illustrated in FIG. 2 (or an apparatus having similar modules, such as a client machine and/or application server). In some embodiments, the method 1100 may occur after the method 1000 and FIG. 10. In operation 1101 in FIG. 11, the classification module 202 determines that a viral promotion seed user has submitted a social activity signal in association with the content item. In operation 1102 in FIG. 11, the promotion module 204 displays, in a content feed viewable by a plurality of members of the online social network service, a prompt indicating that the viral promotion seed user has submitted the social activity signal in association with the content item (e.g., see FIG. 9). In some embodiments, the prompt is selectively displayed in content feeds viewable by members of the online social network service that are followers, first-degree connections, or friends of the viral promotion seed user. While the operation 1102 in FIG. 11 may include displaying the prompt in a content feed, in various embodiments, the prompt may instead or in addition be posted on the member profile page or weblog pages of various members of the online social network service, or the prompt may be transmitted to members of the online social network service in the form of an e-mail message or another type of notification message (e.g., e-mail message, text message, instant message, chat message, etc.).

According to various exemplary embodiments, the promotion module 204 is configured to calculate an advertising cost associated with a viral marketing campaign for an advertiser. This advertising cost may factor in the premium benefit that the advertiser is receiving by having the ability to directly target the underlying content item at the viral promotion seed user. In other words, while conventional online advertising systems may allow an advertiser to select attributes of a large target audience generally (e.g., age, gender, location), the system described herein provides an extremely valuable service by allowing an advertiser to target the content item directly at an individual viral promotion seed user of choice (such as an Influencer on LinkedIn® like Richard Branson, Barack Obama, Arianne Huffington, and so on). This level of targeted content promotion has heretofore not been available. Accordingly, by allowing an advertiser to target their content at this viral promotion seed user, the advertiser is far more likely to successfully launch a viral marketing campaign and achieve their overall advertisement goals (e.g., receiving 1,000,000 likes in a month).

According to various exemplary embodiments, the promotion module 204 may also assess an advertising fee to the advertiser based on the number of users that interacted with the content item (e.g., liked the content item) as a result of the viral marketing techniques described herein. For example, if the content item is targeted successfully at the viral promotion seed user and the viral promotion seed user interacts with that content item, then the promotion module 204 may track how many times that the corresponding interaction prompt is displayed in the content feeds of other users (e.g., see FIG. 9) and, moreover, how many of those other users proceeded to click on that interaction prompt in their content feed. The system may then charge a fee for each of these clicks.

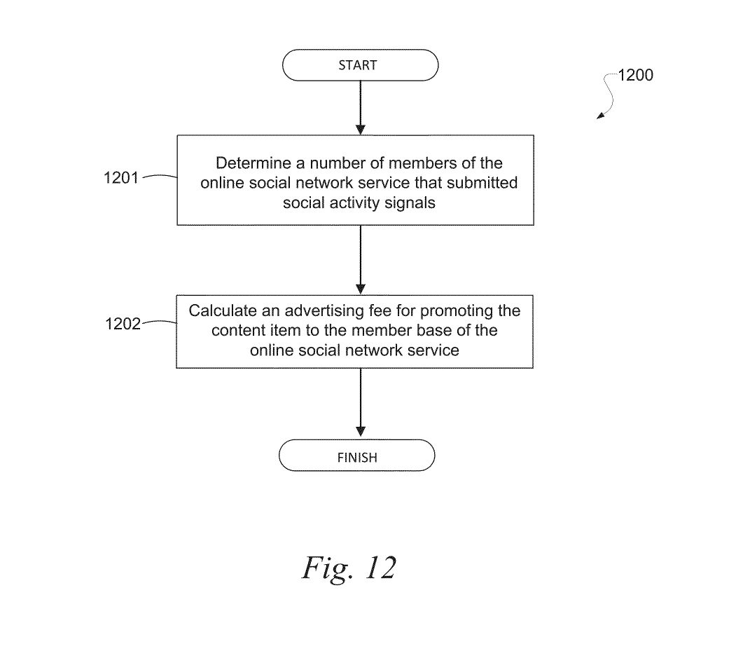

FIG. 12 is a flowchart illustrating an example method 1200, consistent with various embodiments described above. The method 1200 may be performed at least in part by, for example, the viral content promotion system 200 illustrated in FIG. 2 (or an apparatus having similar modules, such as a client machine and/or application server). In operation 1201 in FIG. 12, the promotion module 204 determines a number of members of the online social network service that submit social activity signals in association with a content item after viewing a prompt in a content feed describing a viral promotion seed user's interaction with the content item. In operation 1202 in FIG. 12, the promotion module 204 calculates an advertising fee for promoting the content item to the member base of the online social network service, based on the number of members determined in operation 1201.

According to another exemplary embodiment, when an advertiser wishes to virally promote a particular content item, the promotion module 204 may display that content item on a webpage, web blog, member profile page, LinkedIn® Influencer page, etc., of a viral promotion seed user determined to be an expert or authority on the topic or space to which the underlying content item relates. For example, when an advertiser desires to promote a content item, the promotion module 204 may analyze the content item in order to identify the topic or space to which it relates. For example, the promotion module 204 may look for keywords in the content item and match those keywords to predefined topics such as “big data”, “politics”, “healthcare”, and so on. Alternatively, the promotion module 204 may display a prompt or user interface requesting the advertiser to specify the topic or space to which the underlying content item relates. Thereafter, the promotion module 204 may identify the viral promotion seed user that is an expert in this topic or space. For example, the promotion module 204 may analyze the list of Influencers on LinkedIn® or users on Twitter® that frequently posts content that includes keywords associated with this topic or space and that has received a significant amount of social activity signals (e.g., views, likes, shares, etc.). Accordingly, since visitors that view the Influencer page or web blog page of this viral promotion seed user already have an interest and are already engaged in this topic or space, this may further accelerate the number of social activity signals received by the content item from such users, thereby “jumpstarting” a viral marketing campaign.

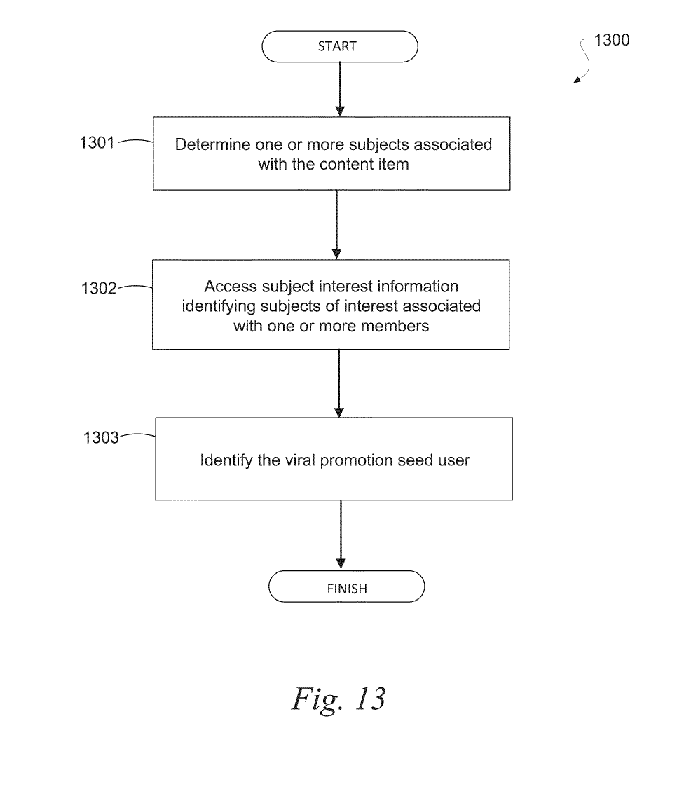

FIG. 13 is a flowchart illustrating an example method 1300, consistent with various embodiments described above. The method 1300 may be performed at least in part by, for example, the viral content promotion system 200 illustrated in FIG. 2 (or an apparatus having similar modules, such as a client machine and/or application server). In some embodiments, the operation 1300 may be included within the operation 1003 in FIG. 10. In operation 1301 in FIG. 13, the classification module 202 determines one or more subjects associated with a content item. In operation 1302 in FIG. 13, the classification module 202 accesses subject interest information identifying subjects of interest associated with one or more members of an online social network service. In operation 1303 in FIG. 13, the classification module 202 identifies a viral promotion seed user, based on a match between the subject interest information associated with the viral promotion seed user (accessed in operation 1302) and the one or more subjects associated with the content item (determined in operation 1301). In some embodiments, the content item may then be displayed on an Influencer page, a member profile page, or a web blog page associated with the viral promotion seed user identified in operation 1303.

According to various exemplary embodiments, the viral content promotion system 200 may be configured to calculate a virality multiplier factor associated with members of an online social network service. In some embodiments, the virality multiplier factor associated with a member of an online social network service may correspond to or be determined based on the number of first-degree connections, friends, followers, etc. that the user may have. In other embodiments, the virality multiplier factor may instead or in addition be determined based on any one of various social metrics described herein. For example, the virality multiplier factor may be weighted based on a social metric such as the likelihood that the user interacts socially with content items. For instance, if a first user tends to like, comment, or share content items more frequently than a second user, then that first user may have a virality multiplier factor that is weighted higher (and is larger) than the virality multiplier factor of the second user. In some embodiments, tendencies to perform different types of social actions may result in a different weights being applied to a virality multiplier factor (e.g., a tendency to like content items may result in a greater virality multiplier factor than a tendency to share content items). In some embodiments, it is possible that each user may have multiple virality multiplier factors associated with them, such as a first virality multiplier factor based on how likely they are to like an article, a second virality multiplier factor determined based on how likely they are to share an article, a third virality multiplier factor determined based on how likely they are to comment on an article, and so on. Accordingly, the system may analyze a user's interaction history and the social activity signals they have submitted (e.g., likes, shares, comments, etc.) in order to calculate a virality multiplier factor associated with them.

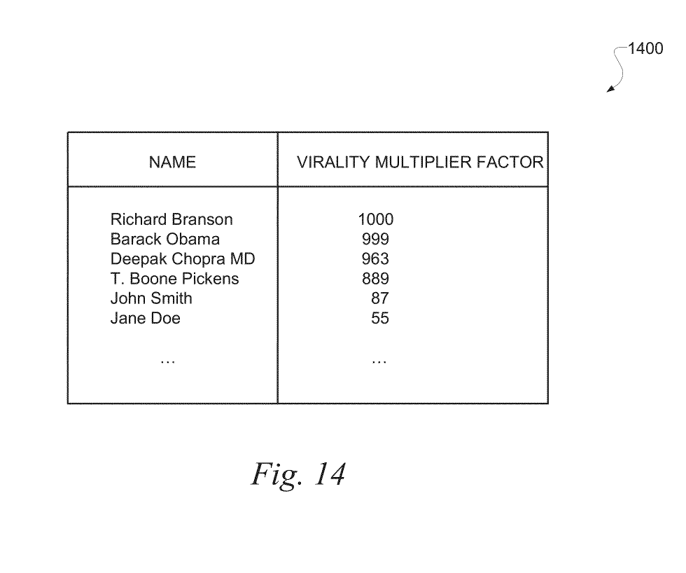

FIG. 14 illustrates an example of virality multiplier factor information 1400 that may be generated and/or maintained by the viral content promotion system 200. As illustrated in FIG. 14, the virality multiplier factor information 1400 identifies various members of an online social network service (e.g., Richard Branson, Barack Obama, etc.) and the virality multiplier factors associated with each of these users that have been calculated by the classification module 202. The virality multiplier factor information 1400 may be stored locally at, for example, the database 206 illustrated in FIG. 2, or may be stored remotely at a database, data repository, storage server, etc., that is accessible by the 200 via a network (e.g., the Internet).

In some embodiments, after determining the virality multiplier factor associated with a member, such a virality multiplier factor may be utilized by the classification module 202 to identify and or recommend particular members as viral promotion seed users. For example, if an advertiser has an advertising campaign objective to receive 1,000,000 likes for a content item, then by analyzing the virality multiplier factors associated with each of various members of an online social network service, the classification module 202 may identify and recommend members with the highest virality multiplier factors.

In some embodiments, the classification module 202 may display a prompt identifying different candidate viral promotion seed users and the virality multiplier factors associated with each of these users (e.g., the list of candidate viral promotion seed user in the user interface 500 in FIG. 5 may also display virality multiplier factors). In this way, an advertiser may easily select a viral promotion seed user for their advertisement campaign having the highest are most appropriate virality multiplier factor. In some embodiments, the advertiser may actually specify a minimum virality multiplier factor when specifying the criteria for a viral promotion seed user (e.g., one of the social metrics illustrated in the user interface 500 may correspond to “virality multiplier factor”).

In some embodiments, the virality multiplier factor associated with a member may directly correlate to a number of social activity signals estimated to occur in response to the corresponding member submitting a social activity signal (e.g., a virality multiplier factor of 1000 indicates that, if the member likes the content item, it is estimated that this content item will receive 1000 likes from other members as a result). For example, by analyzing historical log data maintained by an online social network service, the classification module 202 may determine that when a particular member likes a content item and this interaction is displayed in the content feeds of other members then, on average, 1000 other members will view this interaction and like this content item. Accordingly, this user may have a virality multiplier factor of 1000, which may be compared with the virality multiplier factors of other users in order to determine the estimated number of likes that may be achieved in an advertising campaign. For example, the classification module 202 may inform an advertiser that, for example, a particular user (e.g., Virgin CEO Richard Branson) is a good candidate for a viral promotion seed user because if he likes the underlying content item, 1000 other users are estimated to like the content item. Accordingly, the advertiser is 1000 times more likely to receive a desired outcome of 1000 likes than if they use another viral promotion seed user having a virality multiplier factor of only 1.

According to various exemplary embodiments, the virality multiplier factors may be calculated not only for individual members of an online social network service, but also for segments or groups of users sharing certain attributes, such as age, gender, location, job title, employer, education, school, skills, endorsements, company size, seniority level, groups, etc. For example, the classification module 202 may calculate a virality segment multiplier factor for a segment of users such as “CEOs in Long Island, New York” or “male computer engineers in their 20s in the San Francisco Bay area”, and so on. The classification module 202 may identify all the members of the online social network service that share such attributes, and analyze their user behavior and/or social metrics as described above, in order to generate the average virality multiplier factor for this segment of users. The viral content promotion system 200 may then recommend that a content item is promoted or advertised to one or more user in this segment of users in order to achieve advertising campaign goals. For example, the viral content promotion system 200 may display a prompt in a user interface stating that “since you want to achieve 1 million likes, and CEO's in Long Island, N.Y. have an average virality multiplier factor of 1000, we recommend promoting this content to 1000 CEO's in Long Island”. If the user agrees, then the viral content promotion system 200 may promote the content item accordingly, consistent with various techniques described herein. In some embodiments, a virality multiplier factor may be calculated for various types of online entities associated with an online social network, such as Group entities, School entities, University entities, etc., on the LinkedIn® social network. For example, the virality multiplier factor associated with a particular group entity may reflect the viral influence of the aggregate membership of the group, and/or the viral influence of information available or accessible via the group entity, such as webpages, forums, bulletin boards, conversations, posts, comments, social activity, etc., associated with the group. In some embodiments, a virality multiplier factor associated with a group entity, school entity, university entity, and so on, may be determined based on a number of members, followers, viewers, visitors, etc., of the entity, and/or a quantity of social activity signals or other information posted in connection with the entity.

According to various exemplary embodiments, the advertisement fee charged to advertisers may be calculated at least in part based on the viral multiplication score associated with the viral promotion seed user that the advertiser selects. For example, if a first user has a viral multiplication score of 1000 and a second user has a viral multiplication score of 500, then it is possible that the system may charge the advertiser $10 to target the content item to the first viral promotion seed user and only $5 to target the content item to the second viral promotion seed user.

Various exemplary embodiments and techniques described herein refer to information being displayed and/or received via a user interface. However, the various embodiments and techniques described herein are similarly applicable to the display and/or receipt of information via an Application Programming Interface (API). For example, a social media platforms (e.g., the online social network system 20 illustrate in FIG. 2) may expose or receive information via an API associated with the social media platform that is accessible by other users, websites, software components, applications, modules, and so on, as well understood by those skilled in the art.

According to various exemplary embodiments, the viral content promotion system 200 described herein may facilitate viral marketing via a viral promotion seed user such as an “influencer” as follows: a content or a message (e.g., sponsored content) may be presented to one or more influencers that the system 200 determines are likely to comment, share, like, and follow such content via various analytics (e.g., based on past and present behavior of the influencers). Thereafter, once the influencer likes the content, his or her connections and/or followers can like, or share, or comment, or follow on the content. The followers or connections of these followers/connections will comment, share, like, or follow this piece of content, and so on. This is particularly advantageous because, by virtue of the fact that the individual is a viral promotion seed user or an influencer (e.g., on LinkedIn®), his or her friends or connections are more likely have high factors of virality in their own actions as well (e.g., a CEO's connections are more likely to be CEOs, VPS, etc.). In contrast, traditional content/ad targeting is usually based only on a user's geographic, demographic, behavioral information. Thus, the tools provided by the system 200 allow for extremely powerful targeting options, particularly in the context of social networks.

In some embodiments, the system 200 may first categorize content items, based on some categorization criteria (e.g., category, field, channel, industry, type, subject matter, topic, keywords, etc.). For each person (e.g., viral promotion seed user and/or an influencer) and for each category, the system 200 may calculate an applicable virality factor, based on that person's viral influence with respect to content items associated with that category. For example, the influencer Richard Branson on LinkedIn® may have a high virality factor with respect to the topic of startups, but he may have a very low factor for the topic of baseball. For each person's virality factor per category, the system 200 may further define the virality multiplier factor to be a tuple-value based on various types of social activity (e.g., like factor, share factor, comment factor, follow factor, etc.) instead of just a single number. Moreover, from historic data, the system 200 may calculate a person's 1st degree factors, 2nd degree factors, 3rd degree factors, etc., indicating their viral influence with respect to their 1st degree connections, their 2nd degree connections, 3rd degree connections, and so on.

In some embodiments, the system 200 may provide for a new way of charging customers for online advertising and marketing. For example, a traditional advertisement approach is to charge a customer based on cost per impression (CPM), cost per click (CPC), cost per action (CPA), etc. However, the system 200 may allow a social network service to charge customers based on, for example, a number of 1^{st} degree, 2^{nd} degree, 3^{rd} degree, etc., likes, comments, shares, and follows, etc., that a content item receives. For example, the system 200 may determine the number of 1st degree likes that have resulted after promoting content to a viral seed user or influencer, as well as a number of 2nd degree likes that have resulted from the 1st degree likes, and so on. The system 200 may then determine an appropriate advertising fee (e.g., a flat fee for a 1st degree like, the same fee or a different fee for a 2nd degree like, the same fee or a different free for a 3rd degree like, and so on).

### Example Mobile Device

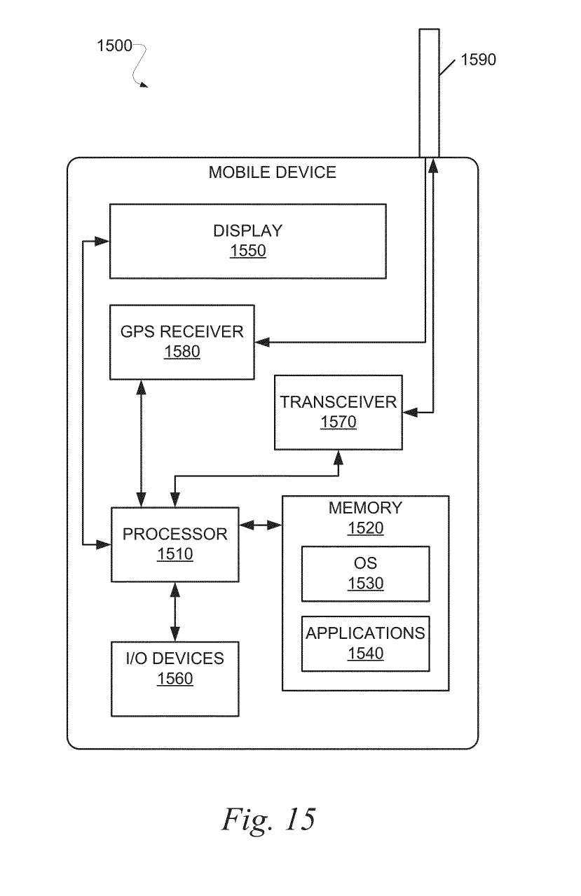

FIG. 15 is a block diagram illustrating the mobile device 1500, according to an example embodiment. The mobile device may correspond to, for example, client machines 110 and 112 or application server 118 illustrated in FIG. 1. One or more of the modules of the system 200 illustrated in FIG. 2 may be implemented on or executed by the mobile device 1500. The mobile device 1500 may include a processor 1510. The processor 1510 may be any of a variety of different types of commercially available processors suitable for mobile devices (for example, an XScale architecture microprocessor, a Microprocessor without Interlocked Pipeline Stages (MIPS) architecture processor, or another type of processor). A memory 1520, such as a Random Access Memory (RAM), a Flash memory, or other type of memory, is typically accessible to the processor 1510. The memory 1520 may be adapted to store an operating system (OS) 1530, as well as application programs 1540, such as a mobile location enabled application that may provide location based services to a user. The processor 1510 may be coupled, either directly or via appropriate intermediary hardware, to a display 1550 and to one or more input/output (I/O) devices 1560, such as a keypad, a touch panel sensor, a microphone, and the like. Similarly, in some embodiments, the processor 1510 may be coupled to a transceiver 1570 that interfaces with an antenna 1590. The transceiver 1570 may be configured to both transmit and receive cellular network signals, wireless data signals, or other types of signals via the antenna 1590, depending on the nature of the mobile device 1500. Further, in some configurations, a GPS receiver 1580 may also make use of the antenna 1590 to receive GPS signals.

### Modules, Components and Logic

Certain embodiments are described herein as including logic or a number of components, modules, or mechanisms. Modules may constitute either software modules (e.g., code embodied (1) on a non-transitory machine-readable medium or (2) in a transmission signal) or hardware-implemented modules. A hardware-implemented module is a tangible unit capable of performing certain operations and may be configured or arranged in a certain manner. In example embodiments, one or more computer systems (e.g., a standalone, client or server computer system) or one or more processors may be configured by software (e.g., an application or application portion) as a hardware-implemented module that operates to perform certain operations as described herein.

In various embodiments, a hardware-implemented module may be implemented mechanically or electronically. For example, a hardware-implemented module may comprise dedicated circuitry or logic that is permanently configured (e.g., as a special-purpose processor, such as a field programmable gate array (FPGA) or an application-specific integrated circuit (ASIC)) to perform certain operations. A hardware-implemented module may also comprise programmable logic or circuitry (e.g., as encompassed within a general-purpose processor or other programmable processor) that is temporarily configured by software to perform certain operations. It will be appreciated that the decision to implement a hardware-implemented module mechanically, in dedicated and permanently configured circuitry, or in temporarily configured circuitry (e.g., configured by software) may be driven by cost and time considerations.

Accordingly, the term “hardware-implemented module” should be understood to encompass a tangible entity, be that an entity that is physically constructed, permanently configured (e.g., hardwired) or temporarily or transitorily configured (e.g., programmed) to operate in a certain manner and/or to perform certain operations described herein. Considering embodiments in which hardware-implemented modules are temporarily configured (e.g., programmed), each of the hardware-implemented modules need not be configured or instantiated at any one instance in time. For example, where the hardware-implemented modules comprise a general-purpose processor configured using software, the general-purpose processor may be configured as respective different hardware-implemented modules at different times. Software may accordingly configure a processor, for example, to constitute a particular hardware-implemented module at one instance of time and to constitute a different hardware-implemented module at a different instance of time.

Hardware-implemented modules can provide information to, and receive information from, other hardware-implemented modules. Accordingly, the described hardware-implemented modules may be regarded as being communicatively coupled. Where multiple of such hardware-implemented modules exist contemporaneously, communications may be achieved through signal transmission (e.g., over appropriate circuits and buses) that connect the hardware-implemented modules. In embodiments in which multiple hardware-implemented modules are configured or instantiated at different times, communications between such hardware-implemented modules may be achieved, for example, through the storage and retrieval of information in memory structures to which the multiple hardware-implemented modules have access. For example, one hardware-implemented module may perform an operation, and store the output of that operation in a memory device to which it is communicatively coupled. A further hardware-implemented module may then, at a later time, access the memory device to retrieve and process the stored output. Hardware-implemented modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., Application Program Interfaces (APIs).)

### Electronic Apparatus and System

Example embodiments may be implemented in digital electronic circuitry, or in computer hardware, firmware, software, or in combinations of them. Example embodiments may be implemented using a computer program product, e.g., a computer program tangibly embodied in an information carrier, e.g., in a machine-readable medium for execution by, or to control the operation of, data processing apparatus, e.g., a programmable processor, a computer, or multiple computers.

A computer program can be written in any form of programming language, including compiled or interpreted languages, and it can be deployed in any form, including as a stand-alone program or as a module, subroutine, or other unit suitable for use in a computing environment. A computer program can be deployed to be executed on one computer or on multiple computers at one site or distributed across multiple sites and interconnected by a communication network.

In example embodiments, operations may be performed by one or more programmable processors executing a computer program to perform functions by operating on input data and generating output. Method operations can also be performed by, and apparatus of example embodiments may be implemented as, special purpose logic circuitry, e.g., a field programmable gate array (FPGA) or an application-specific integrated circuit (ASIC).

The computing system can include clients and servers. A client and server are generally remote from each other and typically interact through a communication network. The relationship of client and server arises by virtue of computer programs running on the respective computers and having a client-server relationship to each other. In embodiments deploying a programmable computing system, it will be appreciated that that both hardware and software architectures require consideration. Specifically, it will be appreciated that the choice of whether to implement certain functionality in permanently configured hardware (e.g., an ASIC), in temporarily configured hardware (e.g., a combination of software and a programmable processor), or a combination of permanently and temporarily configured hardware may be a design choice. Below are set out hardware (e.g., machine) and software architectures that may be deployed, in various example embodiments.

### Example Machine Architecture and Machine-Readable Medium

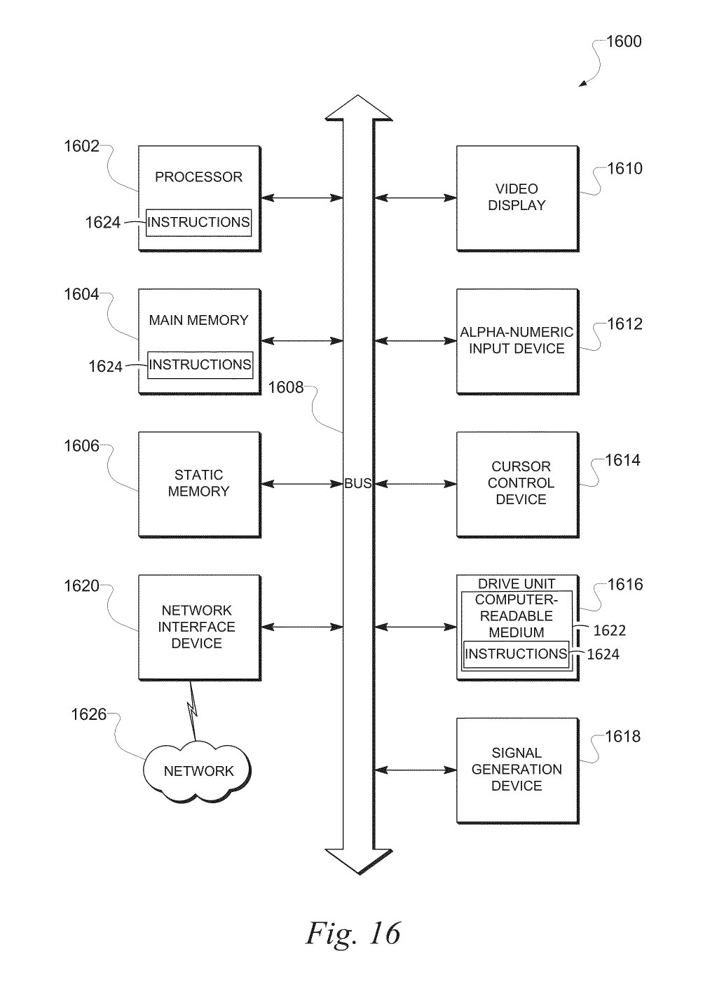

FIG. 16 is a block diagram of machine in the example form of a computer system 1600 within which instructions, for causing the machine to perform any one or more of the methodologies discussed herein, may be executed. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 1600 includes a processor 1602 (e.g., a central processing unit (CPU), a graphics processing unit (GPU) or both), a main memory 1604 and a static memory 1606, which communicate with each other via a bus 1608. The computer system 1600 may further include a video display unit 1610 (e.g., a liquid crystal display (LCD) or a cathode ray tube (CRT)). The computer system 1600 also includes an alphanumeric input device 1612 (e.g., a keyboard or a touch-sensitive display screen), a user interface (UI) navigation device 1614 (e.g., a mouse), a disk drive unit 1616, a signal generation device 1618 (e.g., a speaker) and a network interface device 1620.

### Machine-Readable Medium

The disk drive unit 1616 includes a machine-readable medium 1622 on which is stored one or more sets of instructions and data structures (e.g., software) 1624 embodying or utilized by any one or more of the methodologies or functions described herein. The instructions 1624 may also reside, completely or at least partially, within the main memory 1604 and/or within the processor 1602 during execution thereof by the computer system 1600, the main memory 1604 and the processor 1602 also constituting machine-readable media.

While the machine-readable medium 1622 is shown in an example embodiment to be a single medium, the term “machine-readable medium” may include a single medium or multiple media (e.g., a centralized or distributed database, and/or associated caches and servers) that store the one or more instructions or data structures. The term “machine-readable medium” shall also be taken to include any tangible medium that is capable of storing, encoding or carrying instructions for execution by the machine and that cause the machine to perform any one or more of the methodologies of the present invention, or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include non-volatile memory, including by way of example semiconductor memory devices, e.g., Erasable Programmable Read-Only Memory (EPROM), Electrically Erasable Programmable Read-Only Memory (EEPROM), and flash memory devices; magnetic disks such as internal hard disks and removable disks; magneto-optical disks; and CD-ROM and DVD-ROM disks.

### Transmission Medium

The instructions 1624 may further be transmitted or received over a communications network 1626 using a transmission medium. The instructions 1624 may be transmitted using the network interface device 1620 and any one of a number of well-known transfer protocols (e.g., HTTP). Examples of communication networks include a local area network (“LAN”), a wide area network (“WAN”), the Internet, mobile telephone networks, Plain Old Telephone (POTS) networks, and wireless data networks (e.g., WiFi, LTE, and WiMAX networks). The term “transmission medium” shall be taken to include any intangible medium that is capable of storing, encoding or carrying instructions for execution by the machine, and includes digital or analog communications signals or other intangible media to facilitate communication of such software.

Although an embodiment has been described with reference to specific example embodiments, it will be evident that various modifications and changes may be made to these embodiments without departing from the broader spirit and scope of the invention. Accordingly, the specification and drawings are to be regarded in an illustrative rather than a restrictive sense. The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

What is claimed is:

1. A computer-implemented method comprising:
receiving a user request to promote a content item to a member base of an online social network service;
accessing viral promotion seed user definition information specifying one or more definitions of a viral promotion seed user;
classifying a particular member of the online social network service as the viral promotion seed user, based on the viral promotion seed user definition information; and
selectively promoting the content item to the viral promotion seed user.

2. The method of claim 1, wherein the one or more definitions includes a definition that the viral promotion seed user has a predetermined number of followers, friends, or first-degree connections on the online social network service.

3. The method of claim 1, wherein the one or more definitions includes a definition that the viral promotion seed user is designated as an Influencer member of the online social network service.

4. The method of claim 1, wherein the one or more definitions includes a definition that the viral promotion seed user has submitted a predetermined number of social activity signals in association with content posted on the online social network service.

5. The method of claim 1, wherein the accessing further comprises:
receiving, via a user interface, a user specification of the viral promotion seed user definition information.

6. The method of claim 1, wherein the classifying further comprises:
identifying a plurality of candidate viral promotion seed users, based on the viral promotion seed user definition information; and
receiving, via a user interface, a user selection of the viral promotion seed user from among the plurality of candidate viral promotion seed users.

7. The method of claim 1, wherein the request to promote the content item is received from an advertiser in conjunction with a request for a predetermined number of social activity signals in association with the content item.

8. The method of claim 1, wherein the promoting of the content item to the viral promotion seed user further comprises:
including the content item or a reference link for accessing the content item in a content feed viewable by the viral promotion seed user.

9. The method of claim 1, wherein the promoting of the content item to the viral promotion seed user further comprises:
including the content item or a reference link for accessing the content item in a home page, blog page, or member profile page associated with the viral promotion seed user.

10. The method of claim 1, wherein the promoting of the content item to the viral promotion seed user further comprises:
transmitting an email to the viral promotion seed user including the content item or a reference link for accessing the content item.

11. The method of claim 1, further comprising:
determining that the viral promotion seed user has submitted a social activity signal in association with the content item; and
displaying, in a content feed viewable by a plurality of members of the online social network service, a prompt indicating that the viral promotion seed user has submitted the social activity signal in association with the content item.

12. The method of claim 11, wherein the prompt is selectively displayed in content feeds viewable by members of the online social network service that are followers, first-degree connections, or friends of the viral promotion seed user.

13. The method of claim 11, further comprising:
determining a number of members of the online social network service that, responsive to viewing the prompt in the content feeds, submit social activity signals in association with the content item; and
calculating an advertising fee for promoting the content item to the member base of the online social network service, based on the determined number of members.

14. The method of claim 1, wherein the classifying of the viral promotion seed user further comprises:
determining one or more subjects associated with the content item;
accessing subject interest information identifying subjects of interest associated with one or more members of the online social network service; and
identifying the viral promotion seed user, based on a match between the subject interest information associated with the viral promotion seed user and the one or more subjects associated with the content item.

15. The method of claim 1, further comprising:
calculating an advertising fee for promoting the content item to the viral promotion seed user, based on a virality multiplier factor associated with the viral promotion seed user.

16. The method of claim 16, wherein the virality multiplier factor associated with the viral promotion seed user is determined based on one or more of:
a designation of the viral promotion seed user as an Influencer member of the online social network service;
a number of followers, friends, or first-degree connections of the viral promotion seed user on the online social network service; and
a number of social activity signals posted by the viral promotion seed user in association with content posted on the online social network service.

17. The method of claim 1, further comprising:
determining a virality multiplier factor for a group entity associated with the online social network service.

18. The method of claim 1, wherein the content item is at least one of an advertisement, a news item, a publication, an article, a song, an image, a video, a quote, and a reference link, and
wherein the social activity signals include views, likes, comments, shares, follows, clicks, conversions, or hover responses.

19. A system comprising:
a machine including a memory and at least one processor;
a classification module, executable by the machine, configured to:
receive a user request to promote a content item to a member base of an online social network service;
access viral promotion seed user definition information specifying one or more definitions of a viral promotion seed user; and
classify a particular member of the online social network service as the viral promotion seed user, based on the viral promotion seed user definition information; and
a promotion module configured to selectively promote the content item to the viral promotion seed user.

20. A non-transitory machine-readable storage medium comprising instructions that, when executed by one or more processors of a machine, cause the machine to perform operations comprising:
receiving a user request to promote a content item to a member base of an online social network service;
accessing viral promotion seed user definition information specifying one or more definitions of a viral promotion seed user;
classifying a particular member of the online social network service as the viral promotion seed user, based on the viral promotion seed user definition information; and
selectively promoting the content item to the viral promotion seed user.
